(19) United States
(12) Patent Application Publication
(10) Pub. No.: US 2026/0368612 A1
(43) Pub. Date: Nov. 19, 2026

(54) ARTIFICIAL INTELLIGENCE (AI) BASED METHOD FOR ADAPTIVE CATEGORIZATION OF EVENTS AND SYSTEM THEREOF

(71) Applicant: SKYLARK LABS INC., Bethel, CT (US)

(72) Inventor: AMARJOT SINGH, Bethel, CT (US)

(21) Appl. No.: 18/672,099

(22) Filed: May 23, 2024

(51) Int. Cl. G06N 20/00

(52) U.S. Cl. CPC G06N 20/00

(57) ABSTRACT

The disclosure relates to an Artificial Intelligence (AI) based method and system for adaptive categorization of events. The AI based method includes creating, in real-time, a first set of image vectors and a set of attribute vectors from a multimedia event captured via a camera; comparing the first set of image vectors with a second set of image vectors associated with a plurality of stored multimedia events; determining a first frequency of prior occurrence of the multimedia event based on the comparing; comparing the first frequency of prior occurrence with a frequency threshold; and assigning, via the trained AI model, an event category from a plurality of event categories to the multimedia event, based on comparison of the first frequency with the frequency threshold.

### DESCRIPTION

### Technical Field

The present disclosure relates generally to Artificial Intelligence (AI), and more particularly to a system and a method for adaptive categorization of events using AI.

### Background

Today, in various industrial applications, traditional Artificial Intelligence (AI) systems are extensively employed for categorization of events. The traditional AI systems require large amounts of data samples to learn effectively. The traditional AI systems gradually identify common patterns over time through repetitive exposure to diverse examples. For example, to train an AI system to recognize cars may entail presenting the AI system with numerous car images. This process may allow the AI system to learn common features like tires, windshields, and hoods. However, this process of learning is slow and demands substantial time investment, hindering real-time application deployment. Moreover, once deployed, these traditional AI systems lack capability to quickly learn and adapt to new concepts or events that the traditional AI systems have not encountered during training. Consequently, when confronted with unfamiliar objects, such as bikes, the traditional AI systems may struggle to provide accurate identifications.

Moreover, one challenge faced by the traditional AI systems while performing the categorization is the variability in presentation of recurring events, such as changes in an angle, a scale, or environmental conditions. This variability may make it difficult for the traditional AI systems to accurately identify and classify the events, leading to false positives or missed detections. Moreover, the traditional systems AI systems may struggle to adapt to new or unseen events that do not fit within predefined patterns or templates. This lack of adaptability may limit system's ability to effectively categorize events in dynamic and evolving environments. Additionally, the traditional AI systems may lack sophistication to interpret complex and multi-layered events, particularly in domains where contextual factors play a crucial role.

Therefore, there is a need for a more efficient learning approach capable of rapidly adapting to new knowledge and dynamic environments in real-time, particularly in edge computing scenarios where computational resources are constrained.

### SUMMARY

In one embodiment, an Artificial Intelligence (AI) based method for adaptive categorization of events is disclosed. In one example, the AI based method may include creating, in real-time, a first set of image vectors and a set of attribute vectors from a multimedia event captured via a camera. The AI based method may further include comparing, via a trained AI model, the first set of image vectors with a second set of image vectors associated with a plurality of stored multimedia events. The AI based method may further include determining, via the trained AI model, a first frequency of prior occurrence of the multimedia event based on the comparing. The AI based method may further include comparing the first frequency of prior occurrence with a frequency threshold. The AI based method may further include assigning, via the trained AI model, an event category from a plurality of event categories to the multimedia event, based on comparison of the first frequency with the frequency threshold.

In another embodiment, an Artificial Intelligence (AI) based system for adaptive categorization of events is disclosed. In one example, the AI based system may include a processor and a memory communicatively coupled to the processor. The memory may store processor-executable instructions, which, on execution, may cause the processor to create, in real-time, a first set of image vectors and a set of attribute vectors from a multimedia event captured via a camera. The processor-executable instructions, on execution, may further cause the processor to compare, via a trained AI model, the first set of image vectors with a second set of image vectors associated with a plurality of stored multimedia events. The processor-executable instructions, on execution, may further cause the processor to determine, via the trained AI model, a first frequency of prior occurrence of the multimedia event based on the comparing. The processor-executable instructions, on execution, may further cause the processor to compare the first frequency of prior occurrence with a frequency threshold. The processor-executable instructions, on execution, may further cause the processor to assign, via the trained AI model, an event category from a plurality of event categories to the multimedia event, based on comparison of the first frequency with the frequency threshold.

In yet another embodiment, a non-transitory computer-readable medium storing computer-executable instruction for adaptive categorization of events using Artificial Intelligence (AI) is disclosed. The stored instructions, when executed by a processor, may cause the processor to perform operations including creating, in real-time, a first set of image vectors and a set of attribute vectors from a multimedia event captured via a camera. The operations may further include comparing, via a trained AI model, the first set of image vectors with a second set of image vectors associated with a plurality of stored multimedia events. The operations may further include determining, via the trained AI model, a first frequency of prior occurrence of the multimedia event based on the comparing. The operations may further include comparing the first frequency of prior occurrence with a frequency threshold. The operations may further include assigning, via the trained AI model, an event category from a plurality of event categories to the multimedia event, based on comparison of the first frequency with the frequency threshold.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary environment in which various embodiments may be employed.

FIG. 2 illustrates a functional block diagram of various modules within a memory of a server configured for adaptive categorization of events using Artificial Intelligence (AI), in accordance with some embodiments of the present disclosure.

FIG. 3 illustrates a flow diagram of an exemplary process adaptive categorization of events using Artificial Intelligence (AI), in accordance with some embodiments of the present disclosure.

FIG. 4 illustrates a flow diagram of a process for permanently retaining a multimedia event, in accordance with some embodiments of the present disclosure.

FIG. 5 illustrates an exemplary scenario of retaining a multimedia event permanently, in accordance with some embodiments of the present disclosure.

FIG. 6 illustrates a flow diagram of a process for retaining a multimedia event in a memory of an edge node, in accordance with some embodiments of the present disclosure.

FIG. 7 illustrates an exemplary scenario of retaining a multimedia event in a memory of an edge node, in accordance with some embodiments of the present disclosure.

FIG. 8 illustrates a flow diagram of a process for assigning an event category to a multimedia event based on a frequency of prior occurrence of a similar stored multimedia event, in accordance with some embodiments of the present disclosure.

FIGS. 9A-9D illustrate processing of various exemplary multimedia events, in accordance with some embodiments of the present disclosure.

FIG. 10 illustrates a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

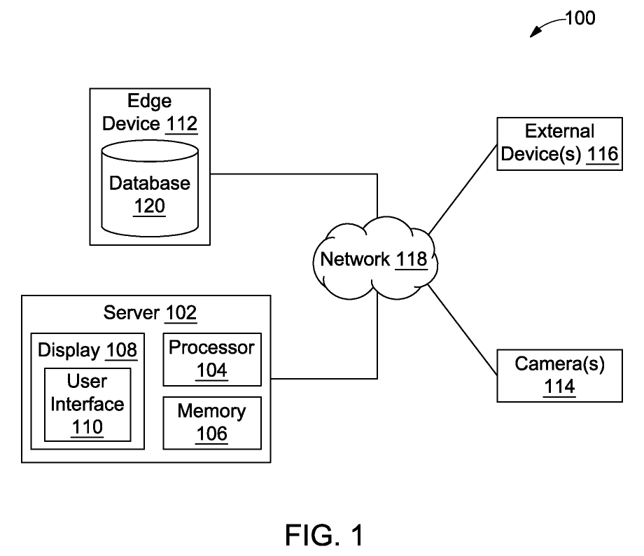

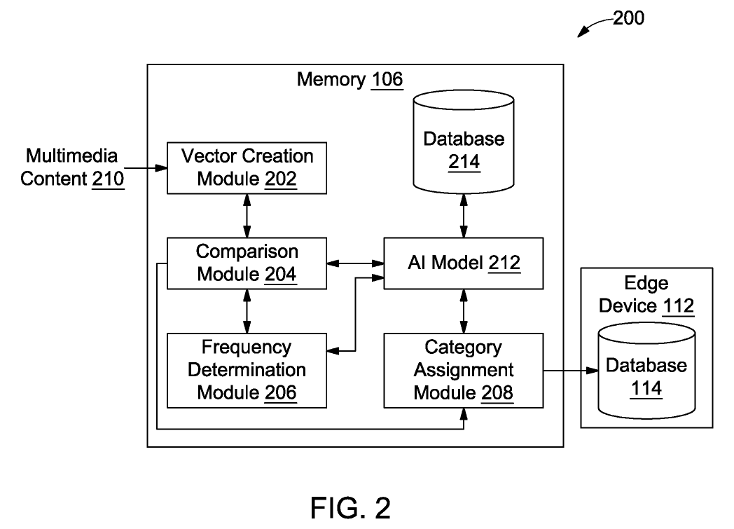

An exemplary environment 100 in which various embodiments may be employed, is illustrated in FIG. 1. The environment 100 may include a server 102. The server 102 may perform adaptive categorization of events using Artificial Intelligence (AI). For example, to perform adaptive categorization, the server 102 may perform various operations including, creating image vectors, creating attribute vectors, comparing image vectors, determining a frequency of prior occurrence of multimedia content, comparing the frequency with threshold, assigning event categories, determining a frequency prior occurrence of stored multimedia event, and the like. This is further explained in detail in conjunction with FIGS. 2-10. Examples of the server 102 may include, but are not limited to, a desktop, a laptop, a notebook, a tablet, a smartphone, a mobile phone, a computing device, or the like. In some embodiments, a primary Artificial Intelligence model (not shown in FIG. 1) may be deployed within the memory 106 of the server 102 that may include an associated database. In one embodiment, the primary AI model may correspond to a supervised AI model.

The server 102 may further include a processor 104 and a memory 106. The processor 104 may include suitable logic, circuitry, interfaces, and/or code that may be configured for performing adaptive categorization of events. The processor 104 may be implemented based on a number of processor technologies, which may be known to one ordinarily skilled in the art. Examples of implementations of the processor 104 may include a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, Artificial Intelligence (AI) accelerator chips, a co-processor, a central processing unit (CPU), and/or a combination thereof.

The memory 106 may store various data (for example, the image vectors, the attribute vectors, multimedia events, frequencies of prior occurrence of the multimedia events, information related to the multimedia events, details about recency of the multimedia events, historical events, event categories, and the like) that may be captured, processed, and/or required by the server 102. The memory 106 may be a non-volatile memory or a volatile memory. Examples of non-volatile memory may include, but are not limited to, a flash memory, a Read-Only Memory (ROM), a Programmable ROM (PROM), Erasable PROM (EPROM), and Electrically EPROM (EEPROM) memory. Examples of volatile memory may include, but are not limited to, Dynamic Random-Access Memory (DRAM), and Static Random-Access memory (SRAM). The memory 106 may also store various data that may be captured, processed, and/or required by the server 102.

The memory 106 may store instructions that, when executed by the processor 104, may cause the processor 104 to perform adaptive categorization of events, in accordance with some embodiments. As will be described in greater detail in conjunction with FIGS. 2-10, in order to perform adaptive categorization of events, the processor 104 in conjunction with the memory 106 may perform various functions including creating the image vectors, creating the attribute vectors, comparing the image vectors, determining the frequency of prior occurrence of multimedia content, comparing the frequency with threshold, assigning the event categories, determining the frequency prior occurrence of stored multimedia event, and the like.

The server 102 may also include a display 108. The display 108 may further include a user interface 110. A user, or an administrator may interact with the server 102 and vice versa through the display 108. By way of an example, the display 108 may be used to display results of analysis (i.e., the multimedia content, the event categories, information about the multimedia event like a source, a target, and severity, a notification about the multimedia event, user interaction options, etc.) performed by the server 102, to the user or the administrator. By way of another example, the user interface 110 may be used by the user or the administrator to provide inputs to the server 102. Thus, for example, in some embodiments, the server 102 may receive an input from the user or the administrator to check details of the multimedia event. Further, for example, in some embodiments, the server 102 may render results to the user/administrator via the user interface 110. For example, the server 102 may render an assigned event category or a new event to the user or the administrator.

In some embodiments, the server 102 may include a computer system such as a desktop computer, notebook or laptop computer, netbook, a tablet computer, an e-book reader, a GPS device, a camera, a personal digital assistant (PDA), a handheld electronic device, a cellular telephone, a smartphone, an augmented/virtual reality device, another suitable electronic device, or any suitable combination thereof and may also include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR.

In some embodiments, the server 102 may further communicate with an edge device 112, camera(s) 114, or external devices 116, via a network 118 for sending and receiving various data. Examples of the edge device 112 may include, but are not limited to, a desktop, a laptop, a notebook, a tablet, a smartphone, a server, an application server, a mobile phone, a computing device, or the like. The edge device 112 may include a database 120 for storing various data captured through the camera(s) 114 for a short period. The database 120 may store information such as multimedia events temporarily for a predefined time duration. For example, initially when an event is seen for a specific short time duration, for the first time, or its priority is low, in that case the event may be stored in the database 120. Further, if the same event is seen frequently, the event may be stored permanently in the memory 106 of the server 102. The edge device 112 may include a secondary AI model (not shown in FIG. 1) and the database 120 may be associated with that secondary AI model. In one embodiment, this secondary AI model may correspond to an unsupervised AI model. In some embodiments, instead of two different AI models (i.e., the primary AI model and the secondary AI model) a single AI model may be deployed. The network 118 may correspond to a communication network that may include a communication medium through which the server 102 may communicate with other devices or databases. Examples of the communication network may include, but are not limited to, Internet, a cloud network, a Wireless Fidelity (Wi-Fi) network, a Personal Area Network (PAN), a Local Area Network (LAN), or a Metropolitan Area Network (MAN).

Various devices in the environment 100 may be configured to connect to the network 118, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

By way of an example, in some embodiments, the server 102 may receive information from the edge device 112, the camera (s) 114, or the external devices 116. For example, the camera(s) 114 may transmit the captured multimedia events to the server 102, where various operations may be performed. Further, the multimedia events may be stored temporarily in the database 120 or permanently in the memory 106 based on their categories. The camera(s) 114 may capture the multimedia events that may be processed to the server 102 as required. Further, the camera(s) 114 may be, but are not limited to, a digital camera, an analog camera, a smartphone camera, an action camera, a webcam, a security camera, a film camera, an aerial camera (for example, a drone camera), a medical camera, a hybrid camera, and the like. It should be noted that in some embodiments, the server 102 may be integrated within the camera(s) 114. The external devices 116 may include, but are not limited to a sensor, a radar, a lidar, and any other data capturing device.

The server 102 may determine frequency of occurrence of the multimedia events and compare it against a predefined frequency threshold. Based on this, the multimedia events may be assigned to either a high priority or low priority category. For high priority events, permanent retention and incremental learning may be performed, while low priority events may be retained for a limited duration at an edge node (in the database 120 of the edge device 112 where predefined actions may be triggered. Additionally, the server 112 allows for further refinement of the assigned category based on associated contextual attributes.

Referring now to FIG. 2, a functional block diagram 200 of various modules within the memory 106 of the server 102 configured for performing adaptive categorization of events using Artificial Intelligence (AI) is illustrated, in accordance with some embodiments of the present disclosure. FIG. 2 is explained in conjunction with FIG. 1. As illustrated in FIG. 2, the memory 106 may include a vector creation module 202, a comparison module 204, a frequency determination module 206, and a category assignment module 208. Also, the memory 106 may include a database (not shown in FIG. 2) to store various data and intermediate results generated by the modules 202-208.

The vector creation module 202 may be configured to create a first set of image vectors and a set of attribute vectors from a multimedia event 210 captured via a camera (such as one of the camera(s) 114). The camera(s) may be, but are not limited to, a digital camera, an analog camera, a smartphone camera, an action camera, a webcam, a security camera, a film camera, an aerial camera (for example, a drone camera), a medical camera, a hybrid camera, and the like. In some embodiments, the vector creation module 202 may create vectors from information such as sensor data, lidar signature, radar signature, data corresponding to cyber-attacks, and the like captured using external devices (such as the external devices 116). Examples of the external devices may include, but are not limited to, a sensor, a lidar, a radar, and the like. The multimedia event 210 may be referred to an incident or activity that is detected and recorded using multiple types of media, such as a video, an audio, or sensor data. The multimedia event 210 may be captured in various forms and analyzed to identify potential threats, monitor critical areas, and investigate security breaches.

In some embodiments, the term "multimedia event" may refer to a single activity. For example, one multimedia event may be “detection of a person” and another multimedia event may be “an attempt to cut through a fence”. Alternatively, in some other embodiments, the term “multimedia event” may refer to a sequence of related activities occurring within a specific time period. For example, the multimedia event may be “a person attempting to cut through a fence followed by arrival of a vehicle to facilitate a smuggling operation”.

Further, for example, in case of aerial reconnaissance, a multimedia event may be a suspicious aerial formation near a military base detected in an aerial video footage captured by a surveillance camera of a drone. By way of an example, in case of marine reconnaissance, the multimedia event may be an unknown vessel entering restricted maritime waters detected in a surveillance camera footage of a coastal monitoring station. By way of an example, in drone reconnaissance, the multimedia event may be a suspicious vehicle moving erratically through city streets detected in a live video feed from a drone flying over an urban area. By way of an example, in accident hotspot detection systems, the multimedia event may be traffic violations at the intersection detected in a traffic camera footage from a busy intersection, indicating a potential accident hotspot.

The first set of image vectors may represent key visual attributes of the multimedia event 210. For example, in the case of images, the first set of image vectors may represent pixel values, shapes, color histograms, visual features, edges, texture features, or other image descriptors. The set of attribute vectors corresponds to a first context associated with the multimedia event 210. For example, the set of attributes may represent verbal exchanges, speech content (e.g., abusive words), a tone of speech (e.g., hateful or angry), a language, spatial relationships (e.g., proximity between individuals), temporal dynamics (e.g., duration of interaction), contextual cues (e.g., interaction between two persons), and the like. The set of attribute vectors enable context-aware analysis, aiding in the identification of events of interest, such as instances of elder abuse in healthcare.

By way of an example, let's consider a scenario where the vector creation module 202 creates a first set of image vectors and a set of attribute vectors from a multimedia event captured via a traffic monitoring camera. The multimedia event may undergo analysis to extract features like vehicle shapes, colors, and positions. For example, in such a case, the first set of image vectors may encode pixel values, color histograms, and texture features, representing visual attributes of a traffic scene. The set of attribute vectors corresponds to contextual cues and interactions within the traffic scene. In one example, the set of attribute vectors may represent a proximity between vehicles, lanes, or objects within the traffic scene. For example, the set of attribute vectors may indicate whether the vehicles are maintaining safe distances or if there's a congestion due to close proximity. In one example, the set of attribute vectors may represent duration and patterns of traffic flow. This may include information about duration of traffic congestion, a frequency of traffic light changes, or fluctuations in vehicle speeds over time. In one example, the set of attribute vectors may be created from audio data available in the traffic scene. The set of attribute vectors may represent any verbal exchanges heard, such as honking, shouting, or communication between drivers and pedestrians. In one example, the set of attributes may encode observable behaviors of drivers or pedestrians, such as aggressive driving maneuvers, yielding to pedestrians, or obeying traffic signals. In one example, the set of attribute vectors may capture contextual information relevant to the traffic scene, such as weather conditions, time of day, road infrastructure, or presence of construction zones or accidents nearby. By integrating information from both the first set of image vectors and the set of attribute vectors, context-aware analysis may be facilitated, enabling detection of events such as road rage incidents or traffic violations in real-time traffic surveillance. Various techniques, including image processing algorithms, computer vision methods, and machine learning models, may be employed to extract and process the relevant information from the multimedia event. The vector creation module 202 may be communicatively coupled to the comparison module 204.

Further, the comparison module 204 may be configured to compare the first set of image vectors with a second set of image vectors. By way of an example, in one embodiment, the first set of image vectors may completely match one of the second set of image vectors. By way of another example, in one embodiment, the first set of image vectors may partially match or similar to one or more of the second set of image vectors. When the first set of image vectors completely match or partially match one of the second set of image vectors, the multimedia event may be considered as a known event. By way of an example, in one embodiment, the first set of image vectors may be completely new or different from any of the second set of image vectors. When the first set of image vectors are completely new or different from any of the second set of image vectors, the multimedia event may be considered as an unknown event or a new event. The second set of image vectors may be associated with a plurality of stored multimedia events. The comparison module 204 may use an AI model 212 (i.e., an AI model with permanent storage) for the comparison. The AI model 212 may correspond to a trained AI model. Further, the AI model 212 may be a supervised AI model. The memory 106 may also include a database 214 associated with the AI model 212. The plurality of stored multimedia events may be available in the database 214.

In some embodiments, the comparison module 204 may be configured to identify a stored multimedia event from the plurality of stored multimedia events. This identification occurs while comparing the first set of image vectors with a second set of image vectors. The stored multimedia event may be similar or partially similar to the multimedia event. In detail, when the first set of image vectors of the multimedia event partially matches or shares some similarities with one or more of the second set of image vectors associated with the stored multimedia event of the plurality of stored multimedia events, then the stored multimedia event may be selected or identified as relevant. The comparison module 204 may be communicatively coupled to the frequency determination module 206, and the category assignment module 208.

By way of an example, consider a traffic surveillance system monitoring a busy intersection. In such a scenario, the comparison module 204 (e.g., a part of the traffic surveillance system) may be configured for analyzing live footage of vehicles passing through the intersection. Initially, each vehicle's image passing through the intersection may be used to create a set of image vectors for comparison. For example, a “red sedan” may pass through the intersection. In such a case, the comparison module 204 may first compare red sedan’s image vectors with image vectors associated various vehicles that may be stored in the database 214, representing various vehicles previously recorded. In one case, the red sedan's image vectors may completely match with the image vectors associated with one of the vehicles stored in the database 214. This may happen if a same red sedan has been captured before in previous surveillance footage. In another case, the red sedan's image vectors may only partially match or bear some similarity to one or more of the image vectors associated with one or more of the vehicles stored in the database 214. This may occur if red sedan's features, such as its color or shape, resemble one or more of other vehicles stored in the database 214. Additionally, there may be instances where the red sedan's image vectors are entirely new or different from any of the vehicles previously recorded in the database 214. This may happen if the red sedan is a unique or uncommon vehicle or not yet encountered by the traffic surveillance system.

The frequency determination module 206 may be configured to determine a first frequency of prior occurrence of the multimedia event based on the comparing. The frequency determination module 206 may utilize comparison results obtained from the comparison module 204, which compares a current multimedia event (e.g., passage of the red sedan) with previously stored multimedia events (e.g., recordings of vehicles passing through the same intersection). Based on these comparisons, frequency determination module 206 may determine a first frequency of prior occurrence of the multimedia event. For example, if the red sedan passing through the intersection has been recorded multiple times in the past, the frequency determination module 206 may determine the frequency of its prior occurrences. This frequency indicates how often the red sedan has been observed in the surveillance footage. For example, the red sedan is recorded passing through the intersection a total of “15” times. In this case, the first frequency of the red sedan's prior occurrence may be “15”. This means that the red sedan has been observed “15” times in the surveillance footage. Thus, the first frequency in this example indicates how frequently the red sedan has been seen passing through the intersection captured by the traffic surveillance system. In some embodiments, the frequency determination module 206 may identify a second frequency of prior occurrence of the stored multimedia event upon identifying the stored multimedia event. For example, when the red sedan's image vectors partially match or bear some similarity to one or more of the image vectors associated with a vehicle of the vehicles stored in the database 214, the frequency determination module 206 may determine a frequency of prior occurrence of that stored vehicle (i.e., the second frequency). For example, the stored vehicle similar to the red sedan is recorded passing through the intersection a total of “10” times. In this case, the second frequency of prior occurrence of the stored vehicle may be “10”. This means that the stored vehicle has been observed “10” times in the surveillance footage. The frequency determination module 206 may use the AI model 212 to determine the first frequency and the second frequency.

Further, the comparison module 204 may also be configured to compare the first frequency of prior occurrence with a frequency threshold (e.g., “20”, “30”, “40”, “50”, “60”, “70”, “100”, “5”, “1000”, or any other number). The frequency threshold may be predefined by an administrator, or the AI model 212 may be trained to consider different frequency thresholds for different scenarios. In some embodiments, the comparison module 204 may determine that the first frequency of prior occurrence is greater than the frequency threshold. For example, consider that the frequency threshold may be “5”. Referring to the previous example, in that case, the first frequency “15” is greater than the frequency threshold “5”. In some other embodiments, the comparison module 204 may determine that the first frequency of prior occurrence is less than or equal to the frequency threshold. By way of an example, when the frequency threshold is “50”, in such a case the first frequency “15” may be less than the frequency threshold “50”. By way of another example, when the frequency threshold is “15”, in such a case the first frequency “15” may be equal to the frequency threshold “15”. In some embodiments, the comparison module 204 may compare the second frequency of prior occurrence with the frequency threshold. For example, in the previous example, the second frequency “10” may be compared with the frequency threshold (e.g., “20”, “30”, “40”, “50”, “60”, “70”, “100”, “5”, “1000”, or any other number). In case the frequency threshold is “20”, the second frequency “10” is less than the frequency threshold is “20”. In case the frequency threshold is “10”, the second frequency “10” is equal to the frequency threshold is “10”. In case the frequency threshold is “5”, the second frequency “10” is greater than the frequency threshold “5”.

The category assignment module 208 may be configured to assign an event category from a plurality of event categories to the multimedia event using the AI model 212. The event category may be assigned based on comparison of the first frequency with the frequency threshold. The plurality of event categories may include a high priority event category and a low priority event category. In some embodiments, when the first frequency of prior occurrence is greater than the frequency threshold, the category assignment module 208 may assign the high priority event category to the multimedia event. For example, when the first frequency is “15” and the frequency threshold “5”, then the high priority event category may be assigned by the category assignment module 208 to the multimedia event (i.e., the red sedan passing through the intersection). In some other embodiments, when the first frequency of prior occurrence is less than or equal to the frequency threshold, the category assignment module 208 may assign the low priority event category to the multimedia event. For example, when the first frequency is “15” and the frequency threshold is “50” or “15”, then the low priority event category may be assigned by the category assignment module 208 to the multimedia event (i.e., the red sedan passing through the intersection). In some embodiments, the multimedia event may be retained permanently in response to assigning of the high priority event category in the database 214. Further, an incremental learning may be performed by the AI model 212 based on the multimedia event. In some embodiments, the AI model may be an ensemble AI model. The AI model 212, which may be a Deep Neural Network (DNN) may recognize and process significant events for permanent retention. Once an event reaches a threshold, it needs be integrated into the database 214 associated with the AI model 212. Moreover, the AI model 212 undergoes a retraining process to incorporate the event's information without compromising its previously acquired knowledge. This retraining ensures that the AI model 212 continues to evolve and adapt, effectively updating its understanding while retaining the previously acquired knowledge it has accumulated over time. Additionally, in some embodiments, the multimedia event may be retained in a memory of an edge node (for example, the database 114 of the edge device 112) for a predefined time duration. The memory may correspond to a memory buffer with a parametric architecture capable of storing a finite number of new events temporarily. The memory buffer serves as a transient storage space. It should be noted that factors such as a frequency, a recency, and a timeframe may be considered to determine when to remove an event from the memory buffer, either discarding it or transitioning it to a permanent storage (i.e., the database 214). These factors collectively determine a significance and a lifespan of events within the memory buffer, facilitating efficient management of memory resources and ensuring that only relevant and timely data is retained. It should be noted that two different approaches may be used to add new knowledge to the database 214 associated with the AI model 212. If the AI model 212 or the database 214 has available capacity, weights corresponding to previous knowledge may be frozen, and new knowledge may be learned using only a secondary set of free weights, implementing a first approach. Alternatively, if the AI model 212 is saturated where accommodating additional information becomes challenging, a second approach may be implemented. In such a scenario, new free weights may be created to accommodate the new knowledge without disturbing the previously learned information. These approaches ensure a seamless integration of new knowledge while maintaining an integrity of existing data within the database 214 and the associated AI model 212. Further, a predefined action may be performed at the edge node (i.e., at the edge device 112) action in response to occurrence of the multimedia event. For example, when a significant event or threat is detected, an automatic notification may be generated to alert relevant parties. The notification may include details like a nature and a severity of the event, a timestamp, and contextual information. Users may then take appropriate action, such as further investigation or intervention, based on the provided information.

In some embodiments, the category assignment module 208 may assign the high priority event category to the multimedia event in response to determining that the second frequency of prior occurrence is greater than the frequency threshold. For example, when the second frequency of prior occurrence of the stored vehicle is “10” and the frequency threshold is “5”, then the multimedia event (i.e., the red sedan passing through the intersection) may assigned with the high priority event category by the category assignment module 208. Alternatively, when the second frequency of prior occurrence of the stored vehicle is “10” and the frequency threshold is “10” or “15”, then the multimedia event (i.e., the red sedan passing through the intersection) may assigned with the low priority event category by the category assignment module 208.

In some embodiments, the category assignment module 208 may modify the assigned category based on the set of attribute vectors created by the vector creation module 202. This means that the categorization process may be refined by considering additional contextual information beyond just the first set of image vectors. The category assignment module 208 may modify the event category assigned to the multimedia event based on the set of attribute vectors if there are instances where a red sedan’s behavior or context indicates a need for a different categorization. For example, consider that the red sedan may initially be assigned the low priority event category. Now, the red sedan may be observed driving erratically, weaving in and out of lanes, and speeding. In such a case, the behavior exhibited by the red sedan suggests aggressive or reckless driving, which may potentially endanger other drivers on road. Consequently, the category assignment module 208 may adjust the low priority event category to a high priority event category. In some embodiments, in addition to frequency or as a part of attribute vectors, recency (i.e., how recently an event occurred) may also be considered for categorizing the multimedia event 210, as it provides context on a current relevance of the multimedia event 210. Recency offers insights into the current relevance of the multimedia event 210, adding valuable context for categorization. This means that not only the frequency but also a timing of an event may influence how it is classified or understood within a given context. It may be noted that the high priority event category may represent an event of interest. An event assigned with the high priority event category may be flagged as significant.

The server 102 employs a criteria to determine whether an event is of interest, with a primary consideration of frequency of occurrence of events. In scenarios where distinguishing identical events is challenging due to variations in appearance caused by factors such as angle, scale, or environmental conditions, retaining of events in a memory of an edge node is employed as a solution. The memory of the edge node serves as a temporary storage mechanism where observed events are tracked over time. The events may be continuously added to the memory of the edge node. Events that cease to occur within a specified timeframe may be removed, while an occurrence count of recurring events may be increased. If an event surpasses a predefined frequency threshold within a predefined time period, it may be flagged as an event of interest. For example, a consistent detection of faces outside a residence or repetitive circling of cars around a government building may trigger such flags. Furthermore, the server 102 may assess similarity of the identified events (current events) to known events (stored events) of interest, facilitating a learning process for these events. By recognizing patterns and characteristics shared with known events, the server 102 may identify and potentially classify new occurrences. Additionally, the server 102 may consider context-aware events of interest, recognizing that certain events may be multi-layered and nuanced. For example, instances of elder abuse by nurses may involve both verbal and non-verbal cues, such as hateful and angry tones, as well as abusive language. Server’s capability to detect such multi-faceted events enables it to respond effectively to complex scenarios. Moreover, the patent outlines additional mechanisms for self-identification of new events, enhancing adaptability and responsiveness to evolving circumstances. Through these combined approaches, the server 102 effectively identifies events of interest, whether based on frequency, similarity to known events, or contextual complexities, enabling proactive detection and intervention in various scenarios.

In some embodiments, the categorization of multimedia events may be presented on a display (such as the display 108) of user interface (such as a dashboard), enabling security analysts or administrators to manually review and assess suspicious activities. The user interface may be configured to highlight anomalies, flag unusual behaviors, and prioritize events and associated threats based on a predefined criteria such as a frequency, a recency, and a severity. For example, the dashboard may visually distinguish between different types of multimedia events and associated threats such as network intrusions, malware detections, and suspicious user activities using color coding, icons, or any other differentiating technique. Further, the analysts or administrators may click on each item associated with the multimedia events to get detailed information about the multimedia events including, but not limited to, a source, a target, a behavior pattern, and any related incidents. This aspect may facilitate immediate awareness and understanding of the multimedia events, empowering users/the analysts/the administrators to make informed decisions on further investigation or take direct mitigation actions.

Further, in some embodiments, the multimedia events may be labelled manually by the analysts, leveraging the information provided on the dashboard, to categorize each multimedia accurately. This process may include a thorough analysis of event’s characteristics, such as the frequency, the recency, behavioral patterns, and an impact. The analysts may label a detected anomaly as "Unauthorized Access Attempt" after reviewing login attempt logs and identifying patterns that deviate from a normal user behavior. This manual intervention may allow for application of human expertise and contextual understanding, ensuring that each event may be labeled with a level of precision and insight that automated systems may not achieve. This manual intervention may also enable incorporation of nuanced event categories that reflect specific security policies and risk tolerance of an organization.

In some embodiments, contextual analysis may be performed for dynamic labelling of the multimedia events. In this approach, a broader context in which a multimedia event occurs may be considered including network environment, targeted systems, and potential impact. Analyzation of these factors may allow for assignment of more specific and informative labels. For example, "Insider Threat: Data Leak" may be assigned to suspicious activities within an organization suggesting an attempt to exfiltrate sensitive information. This approach may recognize that a multimedia event significance and nature may vary based on the context. The contextual analysis may enable security teams to prioritize responses according to each incident's specific circumstances. The contextual analysis may support a more strategic security approach, enabling the organizations to focus resources on the multimedia events with the highest potential impact.

Further, the AI model 212 may Identify and categorize the multimedia events based on intricate behavioral patterns going beyond simple attribute matching. This ability may allow for identification of sophisticated threats. In other words, instead of solely relying on specific characteristics or attributes of a multimedia event, the AI model 212may explore deeper into the behavioral nuances exhibited by the multimedia events, allowing for a more comprehensive understanding and detection. For example, an anomaly demonstrating lateral movement within a network and attempts to escalate privileges may be labeled as an "Advanced Persistent Threat (APT)", denoting considerable sophistication and potential danger. Analyzing the behavioral patterns may enhance comprehension of attackers' tactics, techniques, and procedures (TTPs), facilitating a creation of robust defense strategies.

In some embodiments, severity and impact assessment may be integrated with categorization of events to enable a more nuanced understanding of the multimedia events and associated threats. This aspect may help evaluate a potential damage a threat that may cause, considering factors such as a sensitivity of data at risk, a criticality of affected systems, and threat's capabilities. For example, a multimedia event targeting critical infrastructure may be labeled as "High Severity: Infrastructure Disruption", highlighting both a nature of the multimedia event and its potential consequences. This layered labeling approach may enable organizations to quickly identify and prioritize their response to the most dangerous threats, ensuring that resources are allocated where they are needed most.

It should be noted that the server 102 may be implemented in programmable hardware devices such as programmable gate arrays, programmable array logic, programmable logic devices, or the like. Alternatively, the server 102 may be implemented in software for execution by various types of processors. An identified engine/module of executable code may, for instance, include one or more physical or logical blocks of computer instructions which may, for instance, be organized as an object, module, procedure, function, or other construct. Nevertheless, the executables of an identified engine/module need not be physically located together but may include disparate instructions stored in different locations which, when joined logically together, comprise the identified engine/module and achieve the stated purpose of the identified engine/module. Indeed, an engine or a module of executable code may be a single instruction, or many instructions, and may even be distributed over several different code segments, among different applications, and across several memory devices.

As will be appreciated by one skilled in the art, a variety of processes may be employed for identifying emerging threats in real-time. For example, the exemplary environment 100 and the associated server 102 may perform the AI based adaptive categorization of events, by the process discussed herein. In particular, as will be appreciated by those of ordinary skill in the art, control logic and/or automated routines for performing the techniques and steps described herein may be implemented by environment 100 and the associated server 102 either by hardware, software, or combinations of hardware and software. For example, suitable code may be accessed and executed by the one or more processors on the environment 100 and the associated server 102 to perform some or all of the techniques described herein. Similarly, application specific integrated circuits (ASICs) configured to perform some or all the processes described herein may be included in the one or more processors on the environment 100 and the associated server 102.

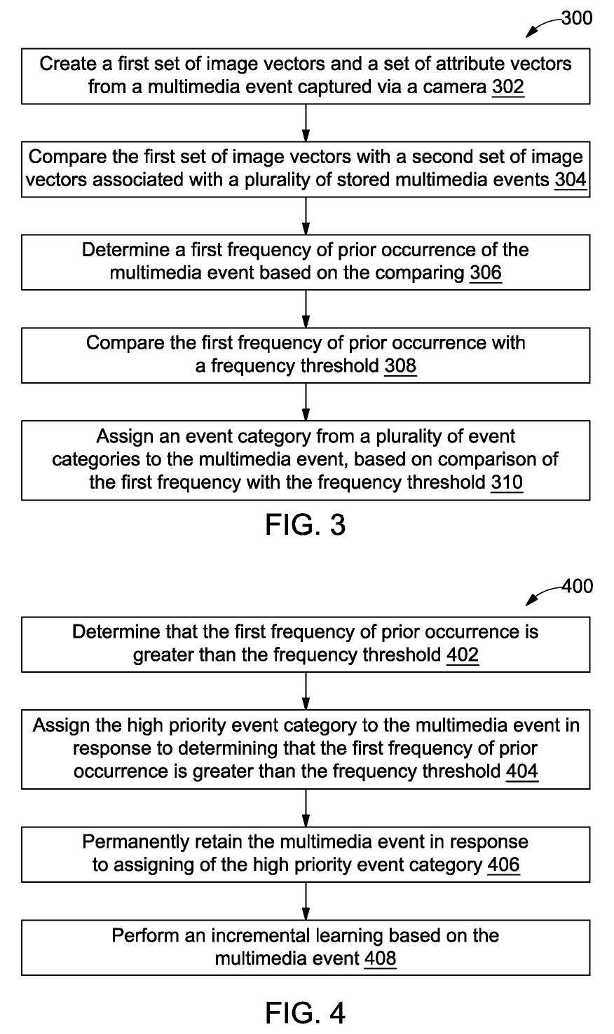

Referring now to FIG. 3, a flow diagram of an exemplary process 300 for performing adaptive categorization of events using Artificial Intelligence (AI) is depicted via a flow chart, in accordance with some embodiments of the present disclosure. Each step of the process 300 may be performed by a server (such as the server 102). FIG. 3 is explained in conjunction with FIGS. 1-2.

At step 302, a first set of image vectors and a set of attribute vectors may be created from a multimedia event (such as the multimedia event 210) captured via a camera. This step may be performed using a vector creation module (such as the vector creation module 202). The camera(s) may be, but are not limited to, a digital camera, an analog camera, a smartphone camera, an action camera, a webcam, a security camera, a film camera, an aerial camera (for example, a drone camera), a medical camera, a hybrid camera, and the like. In some embodiments, vectors from information such as sensor data, lidar signature, radar signature, data corresponding to cyber-attacks, and the like may be created. This information may be captured using external devices (such as the external devices 116). Examples of the external devices may include, but are not limited to, a sensor, a lidar, a radar, and the like. The multimedia event may be referred to an incident or activity that may be detected and recorded using multiple types of media, such as a video, an audio, or sensor data. The multimedia event may be captured in various forms and analyzed to identify potential threats, monitor critical areas, and investigate security breaches.

In some embodiments, the term "multimedia event" may refer to a single activity. For example, one multimedia event may be “detection of a person” and another multimedia event may be “an attempt to cut through a fence”. Alternatively, in some other embodiments, the term “multimedia event” may refer to a sequence of related activities occurring within a specific time period. For example, the multimedia event may be “a person attempting to cut through a fence followed by arrival of a vehicle to facilitate a smuggling operation”.

Further, for example, in case of aerial reconnaissance, a multimedia event may be a suspicious aerial formation near a military base detected in an aerial video footage captured by a surveillance camera of a drone. By way of an example, in case of marine reconnaissance, the multimedia event may be an unknown vessel entering restricted maritime waters detected in a surveillance camera footage of a coastal monitoring station. By way of an example, in drone reconnaissance, the multimedia event may be a suspicious vehicle moving erratically through city streets detected in a live video feed from a drone flying over an urban area. By way of an example, in accident hotspot detection systems, the multimedia event may be traffic violations at the intersection detected in a traffic camera footage from a busy intersection, indicating a potential accident hotspot.

The first set of image vectors may represent key visual attributes of the multimedia event. For example, in the case of images, the first set of image vectors may represent pixel values, shapes, color histograms, visual features, edges, texture features, or other image descriptors. The set of attribute vectors corresponds to a first context associated with the multimedia event. For example, the set of attributes may represent verbal exchanges, speech content (e.g., abusive words), a tone of speech (e.g., hateful or angry), a language, spatial relationships (e.g., proximity between individuals), temporal dynamics (e.g., duration of interaction), contextual cues (e.g., interaction between two persons), and the like. The set of attribute vectors enable context-aware analysis, aiding in the identification of events of interest, such as instances of elder abuse in healthcare.

By way of an example, let's consider a scenario where a first set of image vectors and a set of attribute vectors may be created from a multimedia event captured via a traffic monitoring camera. The multimedia event may undergo analysis to extract features like vehicle shapes, colors, and positions. For example, in such a case, the first set of image vectors may encode pixel values, color histograms, and texture features, representing visual attributes of a traffic scene. The set of attribute vectors corresponds to contextual cues and interactions within the traffic scene. In one example, the set of attribute vectors may represent a proximity between vehicles, lanes, or objects within the traffic scene. For example, the set of attribute vectors may indicate whether the vehicles are maintaining safe distances or if there's a congestion due to close proximity. In one example, the set of attribute vectors may represent duration and patterns of traffic flow. This may include information about duration of traffic congestion, a frequency of traffic light changes, or fluctuations in vehicle speeds over time. In one example, the set of attribute vectors may be created from audio data available in the traffic scene. The set of attribute vectors may represent any verbal exchanges heard, such as honking, shouting, or communication between drivers and pedestrians. In one example, the set of attributes may encode observable behaviors of drivers or pedestrians, such as aggressive driving maneuvers, yielding to pedestrians, or obeying traffic signals. In one example, the set of attribute vectors may capture contextual information relevant to the traffic scene, such as weather conditions, time of day, road infrastructure, or presence of construction zones or accidents nearby. By integrating information from both the first set of image vectors and the set of attribute vectors, context-aware analysis may be facilitated, enabling detection of events such as road rage incidents or traffic violations in real-time traffic surveillance. Various techniques, including image processing algorithms, computer vision methods, and machine learning models, may be employed to extract and process the relevant information from the multimedia event.

At step 304, the first set of image vectors may be compared with a second set of image vectors associated with a plurality of stored multimedia events, using an AI model (same as the AI model 212) and a comparison module (same as the comparison module 204). By way of an example, in one embodiment, the first set of image vectors may completely match one of the second set of image vectors. By way of another example, in one embodiment, the first set of image vectors may partially match or similar to one or more of the second set of image vectors. By way of an example, in one embodiment, the first set of image vectors may be completely new or different from any of the second set of image vectors. The second set of image vectors may be associated with a plurality of stored multimedia events. The AI model may correspond to a trained AI model. Further, the AI model may be a supervised AI model. The AI model may include an associated database (same as the database 214). The plurality of stored multimedia events may be available in the database.

In some embodiments, a stored multimedia event may be identified from the plurality of stored multimedia events. This identification occurs while comparing the first set of image vectors with a second set of image vectors. The stored multimedia event may be similar or partially similar to the multimedia event. In detail, when the first set of image vectors of the multimedia event partially matches or shares some similarities with one or more of the second set of image vectors associated with the stored multimedia event of the plurality of stored multimedia events, then the stored multimedia event may be selected or identified as relevant.

By way of an example, consider a traffic surveillance system monitoring a busy intersection. In such a scenario, live footage of vehicles passing through the intersection may be analyzed. Initially, each vehicle's image passing through the intersection may be used to create a set of image vectors for comparison. For example, a “red sedan” may pass through the intersection. In such a case, the red sedan’s image vectors may be compared with image vectors associated with various vehicles that may be stored in the database, representing various vehicles previously recorded. In one case, the red sedan's image vectors may completely match with the image vectors associated with one of the vehicles stored in the database. This may happen if a same red sedan has been captured before in previous surveillance footage. In another case, the red sedan's image vectors may only partially match or bear some similarity to one or more of the image vectors associated with one or more of the vehicles stored in the database. This may occur if red sedan's features, such as its color or shape, resemble one or more of other vehicles stored in the database. Additionally, there may be instances where the red sedan's image vectors are entirely new or different from any of the vehicles previously recorded in the database. This may happen if the red sedan is a unique or uncommon vehicle or not yet encountered by the traffic surveillance system.

Thereafter, at step 306, a first frequency of prior occurrence of the multimedia event may be determined based on the comparing, using the AI model and a frequency determination module (such as the frequency determination module 206). For example, if the red sedan passing through the intersection has been recorded multiple times in the past, the frequency of its prior occurrences may be determined. This frequency indicates how often the red sedan has been observed in the surveillance footage. For example, the red sedan is recorded passing through the intersection a total of “15” times. In this case, the first frequency of the red sedan's prior occurrence may be “15”. This means that the red sedan has been observed “15” times in the surveillance footage. Thus, the first frequency in this example indicates how frequently the red sedan has been seen passing through the intersection captured by the traffic surveillance system.

At step 308, the first frequency of prior occurrence may be compared with a frequency threshold (e.g., “20”, “30”, “40”, “50”, “60”, “70”, “100”, “5”, “1000”, or any other number) through the comparison module. The frequency threshold may be predefined by an administrator, or the AI model may be trained to consider different frequency thresholds for different scenarios. In some embodiments, it may be determined that the first frequency of prior occurrence is greater than the frequency threshold. For example, consider that the frequency threshold may be “5”. Referring to the previous example, in that case, the first frequency “15” is greater than the frequency threshold “5”. In some other embodiments, it may be determined that the first frequency of prior occurrence is less than or equal to the frequency threshold. By way of an example, when the frequency threshold is “50”, in such a case the first frequency “15” may be less than the frequency threshold “50”. By way of another example, when the frequency threshold is “15”, in such a case the first frequency “15” may be equal to the frequency threshold “15”.

Thereafter, at step 310, an event category may be assigned to the multimedia event from a plurality of event categories using the AI model and a category assignment module (same as the category assignment module 208). The event category may be assigned based on comparison of the first frequency with the frequency threshold. The plurality of event categories may include a high priority event category and a low priority event category. The high priority event category may indicate emergency situations that require immediate attention and action due to their potential to cause harm, loss, or significant damage. Examples of the emergency situations may include, but are not limited to, oil spills, illegal fishing activities, traffic accidents, wildfires; medical emergencies such as heart attacks, strokes, or severe injuries; and man-made disasters such as terrorist attacks or industrial accidents. The low priority event category indicates routine events that are planned activities aimed at preserving or enhancing the functionality, safety, or longevity of equipment, infrastructure, or systems. Examples of the low priority event category include, but are not limited to, regular inspections, software updates, equipment servicing such as engine servicing, facility repairs. In some embodiments, when the first frequency of prior occurrence is greater than the frequency threshold, the high priority event category may be assigned to the multimedia event. For example, when the first frequency is “15” and the frequency threshold “5”, then the high priority event category may be assigned to the multimedia event (i.e., the red sedan passing through the intersection). In some other embodiments, when the first frequency of prior occurrence is less than or equal to the frequency threshold, the low priority event category may be assigned to the multimedia event. For example, when the first frequency is “15” and the frequency threshold is “50” or “15”, then the low priority event category may be assigned to the multimedia event (i.e., the red sedan passing through the intersection).

Referring now to FIG. 4, a flow diagram of a process 400 for permanently retaining a multimedia event is depicted, in accordance with some embodiments of the present disclosure. FIG. 4 is explained in conjunction with FIGS. 1-3.

At step 402, it may be determined that the first frequency of prior occurrence is greater than the frequency threshold using the comparison module. For example, consider that the frequency threshold may be “5”. Referring to the previous example, in that case, the first frequency of prior occurrence of the red sedan is “15” which is greater than the frequency threshold “5”. Thereafter, at step 404, the high priority event category may be assigned to the multimedia event using the category assignment module, in response to determining that the first frequency of prior occurrence is greater than the frequency threshold. For example, the high priority event category may be assigned to the multimedia event (i.e., the red sedan passing through the intersection).

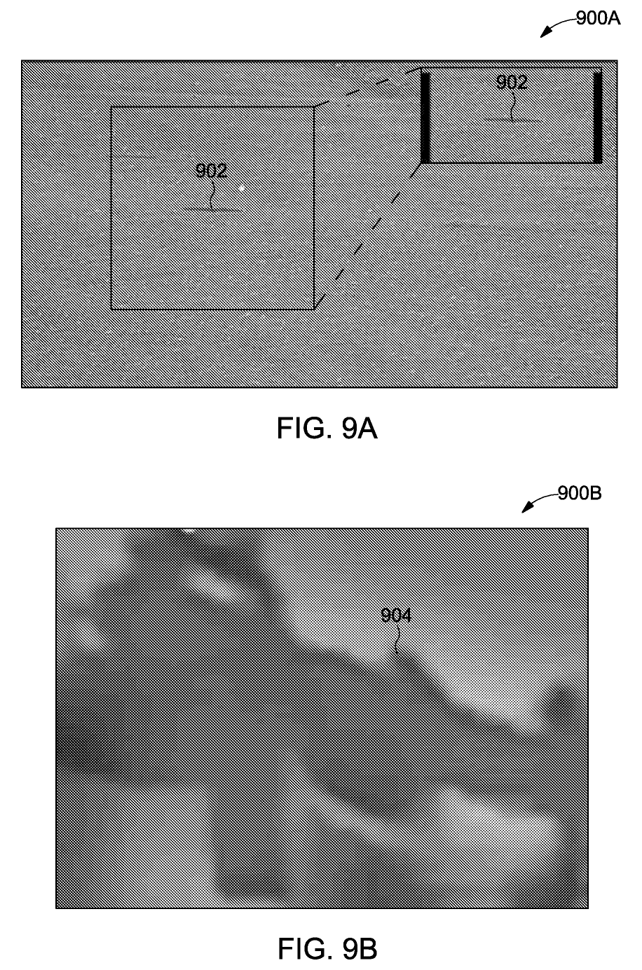

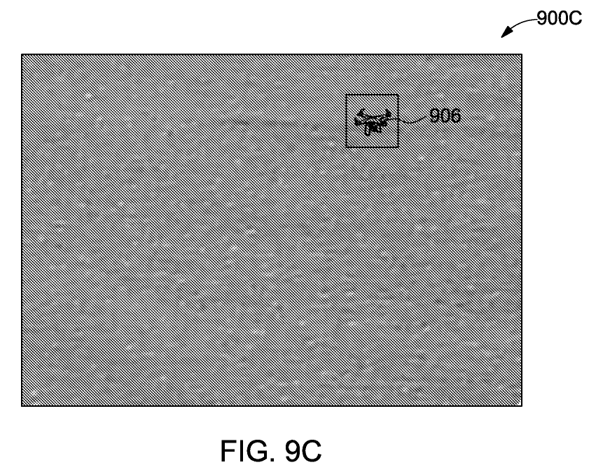

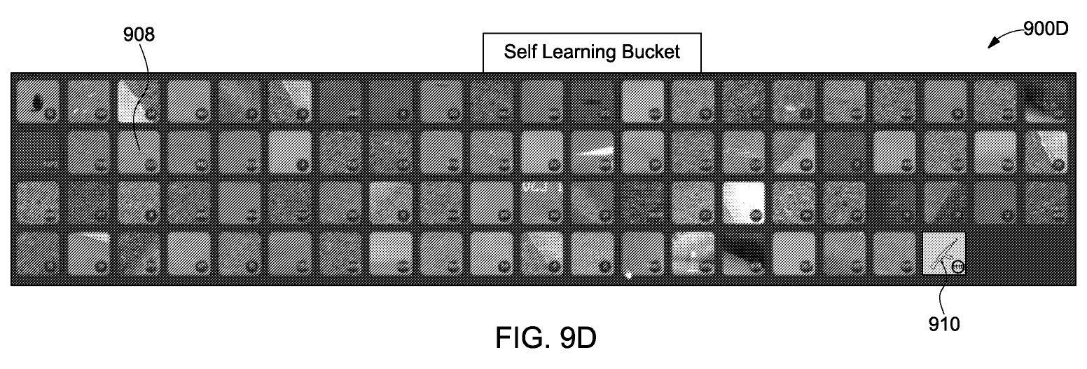

At step 406, the multimedia event may be retained permanently in response to assigning of the high priority event category. Once the high priority event category is assigned to the red sedan, the red sedan may be retained permanently in the database (such as the database 214). At step 408, an incremental learning may be performed by the AI model (same as the AI model 212) based on the multimedia event (i.e., the red sedan passing through the intersection). Number of instances or frequency of prior occurrence of the red sedan may be increased each time the red sedan is identified. This is further explained in detail in FIGS. 9A-9D.

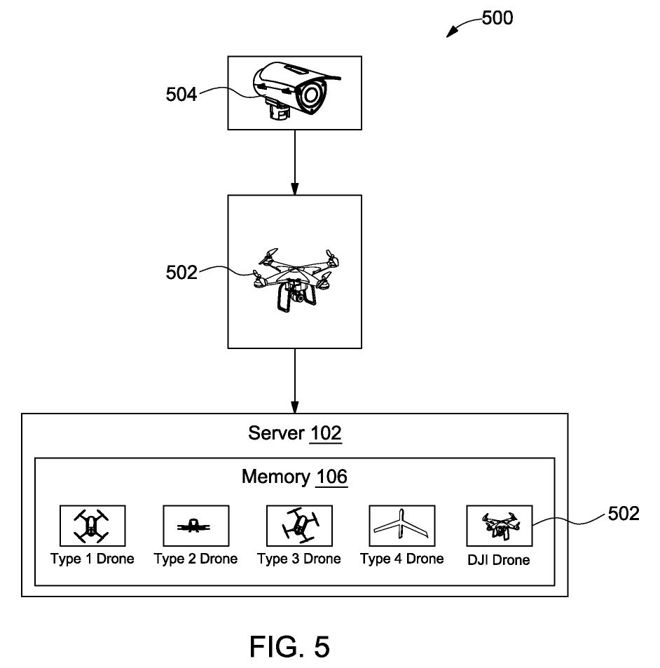

Referring now to FIG. 5, an exemplary scenario 500 of retaining a multimedia event permanently is illustrated, in accordance with some embodiments of the present disclosure. FIG. 5 is explained in conjunction with FIGS. 1-4. In the exemplary scenario 500, a multimedia event 502 may be identification of a “DJI drone”. The “DJI drone” may be captured as the multimedia event 502 using a camera 504, and subsequent processing may be carried out by the server 102. The server 102 may extract image vectors and attribute vectors from the captured multimedia event 502. The image vectors may be then compared with image vectors of various stored drones, labeled as "Type1", "Type2", "Type3", and "Type4" residing in the memory 106 of the server 102. It may be noted that server's memory includes an AI model (similar to the AI model 212), along with an associated database (such as the database 214). This database stores information about different types of drones, labeled as "Type1", "Type2", "Type3", and "Type4".

However, in this particular scenario, the multimedia content 502 (i.e., the DJI drone) captured is absent in the database. Additionally, consider that the multimedia content 702 doesn't share features with any of the existing drones, labeled as "Type1", "Type2", "Type3", and "Type4", stored in the database. Therefore, the DJI drone may be considered a completely new and unidentified drone. Initially, the multimedia event may be stored in a memory of an edge node as the first frequency of prior occurrence of the DJI drone may be “0”. However, the server 102 may continuously track the multimedia event 502, and if the DJI drone is identified, a corresponding instance of frequency may be increased. Once a first frequency of prior occurrence of the multimedia event exceeds a predefined frequency threshold, the multimedia event 502 (i.e., the DJI drone) may be assigned with a high priority event category. This indicates that the DJI drone is encountered frequently enough to meet a threshold criteria for inclusion in the memory 106 permanently. As a result, information about the multimedia event 502 (i.e., the DJI drone) may be retained in the memory 106, specifically in the database 214 associated with the AI model 212. Further, the AI model 212 may perform an incremental learning based on the multimedia event 502.

In another case, consider that some features of the “DJI drone” match with one of the stored drones, such as the “Type 3” drone. In that case, a second frequency of occurrence of the “Type 3” drone may be considered and compared with the predefined frequency threshold. For example, the second frequency of prior occurrence of “Type 3” drone is greater than the predefined frequency threshold. In that case, the “DJI drone” may be assigned with the high priority event category and stored permanently in the database 214 of the memory 106.

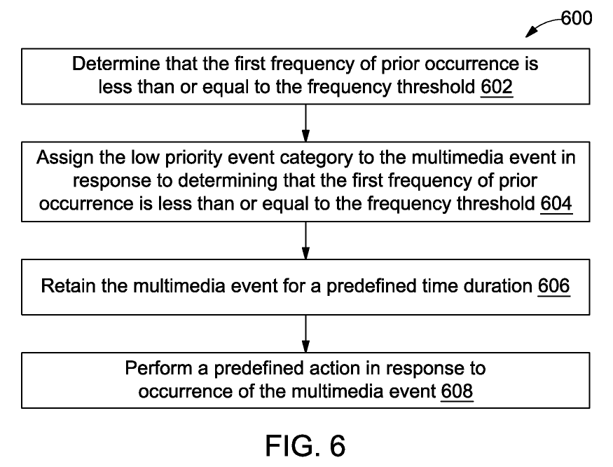

Referring now to FIG. 6, a flow diagram of a process 600 for retaining a multimedia event in a memory of an edge node is depicted, in accordance with some embodiments of the present disclosure. FIG. 6 is explained in conjunction with FIGS. 1-5.

At step 602, it may be determined that the first frequency of prior occurrence may be less than or equal to the frequency threshold. By way of an example, when the frequency threshold is “50” and the first frequency of prior occurrence of the red sedan is “15”, in such as case, the first frequency “15” is less than the frequency threshold “50”. By way of another example, when the frequency threshold is “15”, and the first frequency of prior occurrence of the red sedan is “15”, in such as case, the first frequency is equal to the frequency threshold “15”. At step 604, the low priority event category may be assigned to the multimedia event in response to determining that the first frequency of prior occurrence is less than or equal to the frequency threshold. For example, the low priority event category may be assigned to the red sedan.

At step 606, the multimedia event may be retained for a predefined time duration in a memory of an edge node (such as in the database 120 of the edge device 120) or temporarily. The predefined time duration may be expressed in one of seconds, minutes, hours, days, and years. For example, if an event does not reoccur within the predefined time duration, it may be removed from the memory. Conversely, if an event reoccurs frequently and exceeds the frequency threshold, it may be retained permanently which is already explained in FIG. 4. At step 608, a predefined action may be performed in response to occurrence of the multimedia event at the edge node (i.e., at the edge device 120). For example, if a significant event, anomaly, or threat is detected, a notification may be generated automatically. This notification serves as a means of alerting relevant parties or users about the detected issue. Content of the notification may typically provide pertinent details about the event, or the issue identified at the edge device. The notification may include information such as a nature of the detected event, its severity level, a timestamp, and possibly contextual information derived from the multimedia event. This contextual information may aid in understanding a situation and determining an appropriate course of action. Upon receiving the notification, the users may then take appropriate action based on the information provided. This action may involve further investigation, intervention, or decision-making to address the detected issue effectively. This helps empower users with timely and actionable insights at the edge, thereby facilitating swift responses to emerging events or challenges.

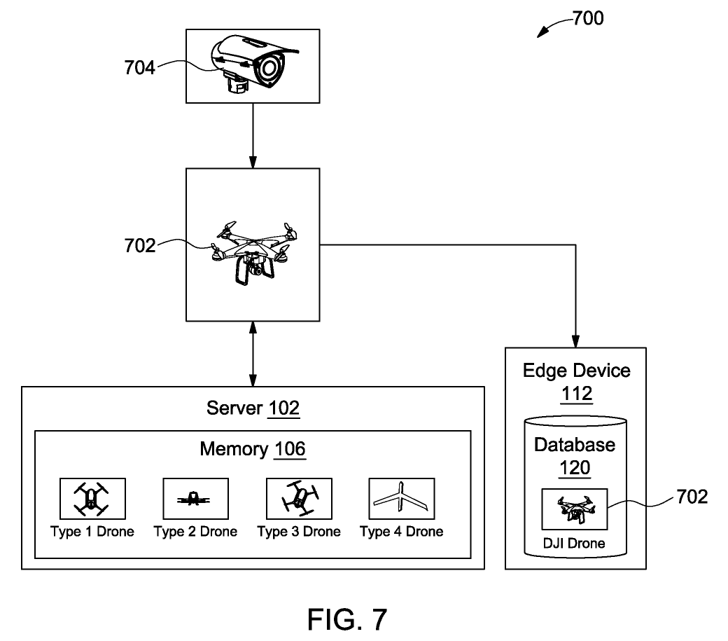

Referring now to FIG. 7, an exemplary scenario 700 of retaining a multimedia event in a memory of an edge node is illustrated, in accordance with some embodiments of the present disclosure. FIG. 7 is explained in conjunction with FIGS. 1-6. In the exemplary scenario 700, a multimedia event 702 may be identification of a “DJI drone”. The “DJI drone” may be captured as the multimedia event 702 using a camera 704, and subsequent processing may be carried out by the server 102. The server 102 may extract image vectors and attribute vectors from the captured multimedia event 702. The image vectors may be then compared with image vectors of various stored drones, labeled as "Type1", "Type2", "Type3", and "Type4" residing in the memory 106 of the server 102. It may be noted that server's memory includes an AI model (similar to the AI model 212), along with an associated database (such as the database 214). This database stores information about different types of drones, labeled as "Type1", "Type2", "Type3", and "Type4".

However, in this particular scenario, the multimedia content 702 (i.e., the DJI drone) captured is absent in the database. Additionally, consider that the multimedia content 702 doesn't share features with any of the existing drones, labeled as "Type1", "Type2", "Type3", and "Type4", stored in the database. Therefore, the DJI drone may be considered a completely new and unidentified drone. It should be noted that the multimedia content 702 may be picked up once it is encountered, in the memory of an edge node, as a temporary knowledge. When a first frequency of occurrence of the DJI drone is determined, it may be found to be less than a predefined threshold. This indicates that the DJI drone is encountered but not frequently enough to meet a threshold criteria for inclusion in the memory 106 permanently. As a result, a low priority event category may be assigned to the multimedia event 702 and information about the multimedia event 702 (i.e., the DJI drone) may be retained in the memory of an edge node, specifically the database 120 of the edge device 112. Additionally, if the DJI drone is not observed for a specific duration or fails to appear again within that timeframe, in such a case the information about the DJI drone may be removed from the database 120. Removing the DJI drone from the database 120 helps maintain database efficiency and prevents unnecessary clutter with data that may no longer be relevant or useful.

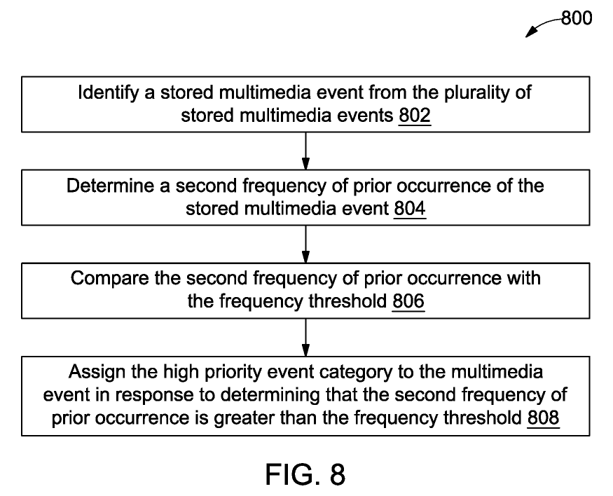

Referring now to FIG. 8, a flow diagram of a process 800 for assigning an event category to a multimedia event based on a frequency of prior occurrence of a similar stored multimedia event is depicted, in accordance with some embodiments of the present disclosure. FIG. 8 is explained in conjunction with FIGS. 1-7.

At step 802, a stored multimedia event may be identified from the plurality of stored multimedia events while comparing the first set of image vectors with a second set of image vectors. It should be noted that the stored multimedia event may be similar to the multimedia event. For example, a maroon hatchback may be identified in the stored multimedia events which is similar to the red sedan based on their image vectors. At step 804, a second frequency of prior occurrence of the stored multimedia event may be determined. For example, a frequency of prior occurrence of the maroon hatchback may be determined. In simple words, how many times this particular event (e.g., the maroon hatchback) has been encountered or recorded before may be checked.

At step 806, the second frequency of prior occurrence may be compared with the frequency threshold. For example, the frequency of prior occurrence of the maroon hatchback stored in the database may be “10” and the frequency threshold may be “5”. So, the value “10” may be compared with the value “5”. At step 808, the high priority event category may be assigned to the multimedia event in response to determining that the second frequency of prior occurrence is greater than the frequency threshold. For example, the high priority event category may be assigned to the red sedan, as the frequency of prior occurrence of the maroon hatchback is higher than the frequency threshold.

Referring now to FIGS. 9A-9D, processing of various exemplary multimedia events (such as a multimedia event 900A, a multimedia event 900B, and a multimedia event 900C) is depicted, in accordance with some embodiments of the present disclosure. FIGS. 9A-9D are explained in conjunction with FIGS. 1-8. FIG. 9A includes the multimedia event 900A. The multimedia event 900A further includes a tarmac oil patch 702. When the multimedia event 900A is processed, it may be observed that image vectors of the tarmac oil patch 702 completely match with image vectors of a stored tarmac oil patch 908 corresponding to a stored event within a database 900D (i.e., a self-learning bucket). The database 900D may include various stored events. Each of the stored events may be labelled with a number, indicating a frequency of occurrence of each of the stored events. For example, as illustrated in FIG. 9D, a frequency of occurrence of the stored tarmac oil patch 908 may be “323”. Consequently, this number may increase by one each time the same multimedia event is identified. This multimedia event may be assigned with the high priority event category as the frequency of occurrence “323” is high and the event is one of the recent multimedia events.

Referring to FIG. 9B, the multimedia event 900B includes a gun 904 (i.e., a weapon). It may be apparent from FIG. 9B that a top part of the gun 904 is blurred or not properly visible. Thus, other parts of the gun 904 may be considered for image vector comparison. When image vectors of the gun 904 are compared with image vectors of each of stored multimedia events in the database 900D, it may be found that some features of the gun 904 (for example, a handle) match with some features of a stored gun 910 corresponding to a stored multimedia event within the database 900D. In other words, there is a partial match between the gun 904 and the stored gun 910. Further, in this case, a frequency of occurrence of the gun 910 (i.e., a second frequency) may be checked for assigning an event category to the gun 904. Additionally, attribute vectors of the gun 904 may also be considered while assigning the event category to the gun 904. For example, the gun 904 may be assigned with the high priority event category, as the frequency of occurrence of the gun 910 is “1110” which is a high value. Thus, rather than requiring a complete structure to match, objects may be identified, labeled, or categorized, based on a presence of specific parts or features. Even if only a portion of a structure is visible or recognizable, the categorization and labelling may be performed accordingly. For example, the gun 904 may be identified as a gun based on recognition of specific features.

Referring to FIG. 9C, the multimedia event 900C includes a drone 906. When image vectors of the drone 906 are compared with image vectors of each of stored multimedia events in the database 900D, it may be found that features of the drone 906 are absent in all of the stored multimedia events within the database 900D. This indicates that the multimedia event 900C is encountered for the first time, and its frequency of prior occurrence recorded may be zero. As the frequency of prior occurrence is less, the multimedia event 900C may be assigned with a low priority event category. Consequently, the multimedia event 900C that includes the drone 906 may be temporarily stored in the database 900D to facilitate further analysis and potential future references. However, if the multimedia event 900C is not encountered within a predefined time period in future, the multimedia content 900C may be considered unnecessary to retain in the database 900D, leading to its removal. Alternatively, if the multimedia event 900C continues to occur and its frequency of occurrence surpasses the predefined frequency threshold, the multimedia event 900C may be retained permanently in the database 900D.

It should be noted that when a particular event is identified once in a single moment, that event may be immediately picked up. This may be referred to as a temporary knowledge. Meanwhile, the memory buffer may store different versions of something that is encountered repeatedly. The memory buffer keeps track of these variations. When the event is deemed significant enough for permanent retention, the AI model undergoes a gradual training process on the multiple variations stored in the memory buffer.

For brevity few examples are provided in the disclosure, however the disclosure may be broadly applicable across various fields. The disclosure includes an AI model that may be used in identification of various types of cyber-attacks, cancer patterns, protein structures, and other potentially problematic patterns. The disclosure enables identification of new patterns of interest, even those outside its existing framework. Once the new patterns of interest are identified, these patterns may be flagged and added to a knowledge base or a database for further recognition. This allows the AI model to learn and make predictions based on both known and newly discovered patterns, enabling proactive or reactive alert types depending on the context. Overall, the disclosure facilitates a detection and response to emerging threats or anomalies across different domains, leveraging both existing knowledge and continuous discovery.

Additionally, even if the frequency of occurrence remains low and the low priority event category is assigned to the multimedia event 900C, the event category may be modified to may the high priority event category if the attribute vectors associated with the multimedia event 900C indicate suspicious characteristics, such as anomalous behavior or unusual patterns. In such cases, the multimedia event 900C and the drone 906 may be retained permanently in the database 900D, regardless of its frequency of occurrence, to ensure its availability for further analysis and investigation.

By way of an example, in some embodiments, the disclosure may be implemented in a border surveillance system. The border surveillance system may employ an AI model (same as the AI model 212). The border surveillance system may include cameras to capture various activities. The border surveillance system may swiftly and effectively detect known, partially known, and unknown emerging threats along borders and critical areas. The border surveillance system may analyze images captured by the cameras, breaking the images into essential details like how often something occurs, when it happened recently, any unique patterns noticed, and how intense the activity seems. Thereafter, based on past events stored in a database (for example, the database 214), the border surveillance system may compare a current situation (i.e., a current event) with similar incidents from the past. For example, if it is a vehicle approaching a border under the cover of darkness, the border surveillance system may access past instances of such occurrences. Further, the border surveillance system may determine a proximity of the current event with historical situations (i.e., the historical events). It should be noted that different factors like a frequency, a recency, a pattern, and an intensity of activities may be considered while determining the proximity.

Based on the comparison, the border surveillance system may decide if the current event is something that has been seen before, or if the current event is partially new or entirely new, and potentially dangerous. For example, if the current event closely matches a known smuggling route. In such a case, an alarm may be generated, or a user may be notified. If the border surveillance system determines that a new threat is emerging, such as an unauthorized border crossing, the border surveillance system promptly may notify the relevant authorities. Simultaneously, the border surveillance system may update the database with detailed information about this new event and the new threat. Thus, border surveillance systems enhance its ability to detect and respond to similar incidents in the future. This proactive approach ensures that the authorities may take swift action to address the threat, while also supporting system's effectiveness over time by continuously learning from and adapting to evolving situations. In some embodiments, the border surveillance system may determine an event category from a plurality of event categories to the multimedia event, based on comparison of frequencies. Further, in case of the high priority event, a corresponding event may be retained permanently and, an incremental learning may be performed by the AI model based on that event. In case of the high priority event, a corresponding event may be retained in a memory of an edge node for a predefined time duration.

The border surveillance system may leverage advanced surveillance technology, including, but not limited to, thermal imaging and motion sensors. As a result, the border surveillance system may offer comprehensive monitoring capabilities to ensure enhanced safety and security. Further, the border surveillance system may detect emerging threats rapidly. For example, the border surveillance system may identify the threats in real-time whether it is unauthorized border crossings, suspicious activities, or potential security breaches. The border surveillance system may monitor large stretches of border territory, providing constant vigilance against intrusions or unlawful activities.

In some embodiments, the border surveillance system may help securing national borders against various threats and unauthorized activities. By way of an example, the border surveillance system may detect the threats and the unauthorized activities including perimeter intrusion, drifting and suspicious activity, concealed weapons, and cross-border movement. Additionally, in some embodiments, the border surveillance system may enhance security within military bases and other critical defense installations. For example, the border surveillance system may perform VIP vehicle identification, environmental hazard detection, tarmac, and sensitive area monitoring.

Moreover, the border surveillance system may help safeguard critical defense infrastructure and assets, particularly in strategic locations. For example, the border surveillance system may perform crowd formation analysis, movement pattern recognition, equipment and vehicle monitoring, and monitoring changes in environmental structures.

By way of an example, in some embodiments, the disclosure may be implemented in aerial reconnaissance and elimination systems (ARIES). In such a case, the ARIES may ensure comprehensive airspace security. The ARIES may provide advanced surveillance, threat prediction, and rapid response capabilities by detecting and tracking all airborne objects. The ARIES may also include ground-based systems for early warning and protection of military bases, government buildings, and airports against aerial threats. The ARIES may enhance security through advanced global defense strategies and border surveillance capabilities. For example, the ARIES may perform Unmanned Aerial Vehicle (UAV) detection, military aircraft monitoring, flight pattern analysis, real-time airspace mapping. Further, the ARIES may help Implement sophisticated safety measures and event management systems for urban environments and large-scale events. For example, the ARIES may perform object recognition, behavioral analysis, alert generation and threat prioritization, and the like. In some embodiments, the ARIES may analyze UAV patterns and formations to identify coordinated threats, enhancing situational awareness and countermeasure planning, for example by performing UAV pattern and formation analysis, providing enhanced situational awareness, identification of coordinated threats, and providing support in countermeasure planning.

By way of another example, in some embodiments, the disclosure may be implemented in Marine Reconnaissance Systems (MIRAS). The MIRAS may detect suspicious behaviors and focus on labeling of the suspicious behaviors and proactively alert against the suspicious behavior near coastal areas and water boundaries. The MIRAS may safeguard marine environments by tracking vessels and identifying critical threats, such as unknown vessels, fisherman vessels, ship traffic, and the like. The MIRAS may detect unknown vessels at sea to identify potentially illegal activities. The MIRAS help securing maritime borders and coastal areas against unauthorized activities, smuggling, and security threats through labelling of maritime intrusion detection, suspicious vessel tracking, underwater movement detection, and coastal activity analysis. Further, the MIRAS may ensure safety and security of commercial and military ports, including cargo and personnel movements through the labelling of vessel tracking monitoring, container and cargo inspection, unauthorized access reporting, and critical infrastructure and asset protection. Additionally in some embodiments, the MIRAS may identify and prevent illegal fishing activities, preserving marine ecosystems, and enforcing fishing regulations through unauthorized fishing vessel identification, overfishing activity monitoring, protected species and habitat surveillance, and cross-border fishing activity tracking. Further, the MIRAS may provide critical capabilities for search and rescue operations, enforce maritime laws, and support underwater archaeological research and exploration, ensuring legal compliance and safety at sea. For example, the MIRAS may perform search and rescue operations, maritime legal enforcement, and archaeological and historical research. Moreover, the MIRAS may safeguard marine ecosystems and focus on conducting environmental research, assessing climate change impacts, managing oil spill responses, and monitoring aquaculture through maritime environmental research, oil spill detection and response, climate change impact assessment, and aquaculture monitoring.

By way of an example, the disclosure may have a utility in Drone Reconnaissance and Observation System (DROS). The DROS may utilize drones to identify different concepts, such as people, vehicles, infrastructure etc., in optical and thermal modalities to provide actionable insights to law enforcement agencies. For example, the DROS may identify and label intrusion, violence and riot, suspicious vehicles and traffic. The DROS may identify objects of interest through drones. The DROS seamlessly integrates military-grade drones with optical and thermal capabilities. The DROS excels in detecting and labelling unknown objects, individuals, and vehicles, significantly enhancing situational awareness and operational effectiveness. The DROS is a cutting-edge solution that identifies potential threats in real-time, ensuring timely alerts to authorities. In some embodiments, the DROS may monitor urban environments for security and public safety through riot and disturbance monitoring, urban traffic analysis, public event surveillance, and critical infrastructure watch. The DROS may enhance law enforcement capabilities with advanced drone reconnaissance through crime scene analysis, suspect tracking and identification, covert surveillance operations, and emergency response coordination. Further, the DROS may provide strategic intelligence and environmental oversight using drone technology through geographical and environmental surveillance, border patrol and security, natural disaster assessment and response, and wildlife and environmental conservation.

By way of an example, the disclosure may have a utility in accident hotspot detection and self-labelling. The real-time driver alerts about accident-prone conditions may be enhanced with a self-learning capability to detect new curves, patterns, and evolving risk factors. The disclosure leverages real-time road condition data and historical incident analysis, continually adapting and updating its algorithms. This dynamic adaptation ensures that the driver receives the most relevant and timely warnings, tailored to constantly changing factors that contribute to accident risks on the road. The disclosure significantly boosts safety by proactively identifying and responding to new and emerging threats in driving environments.

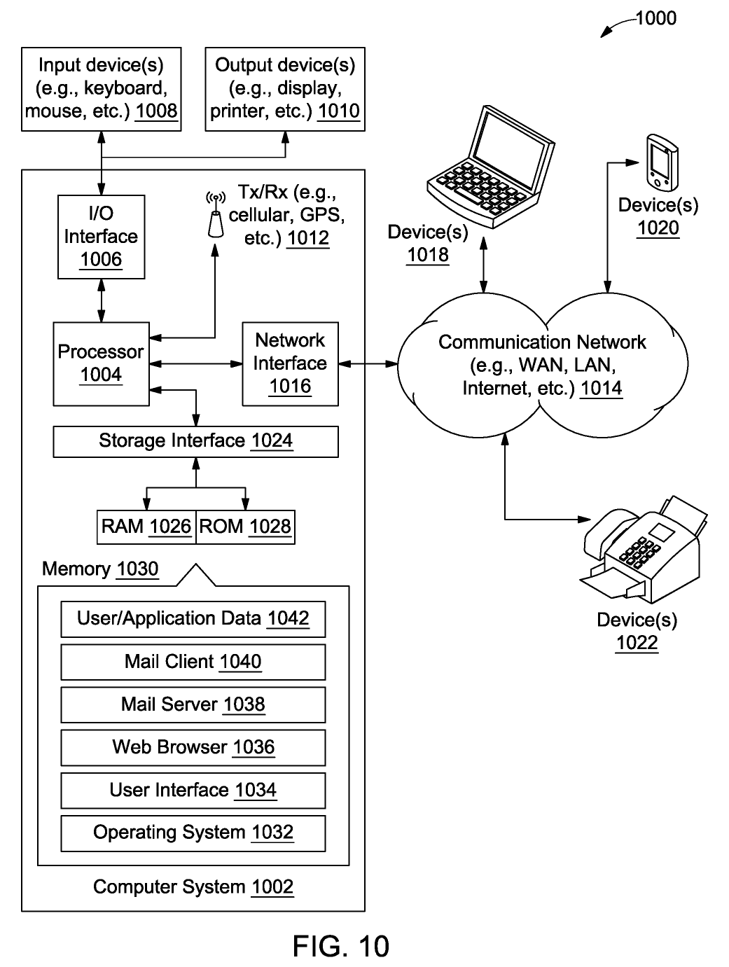

Referring now to FIG. 10, a block diagram 1000 of an exemplary computer system 1002 for implementing various embodiments is illustrated. Computer system 1002 may include a central processing unit (‘CPU’ or ‘processor’) 1004. Processor 1004 may include at least one data processor for executing program components for executing user or system-generated requests. A user may include a person, a person using a device such as such as those included in this disclosure, or such a device itself. Processor 1004 may include specialized processing units such as integrated system (bus) controllers, memory management control units, floating point units, graphics processing units, digital signal processing units, etc. Processor 1004 may include a microprocessor, such as AMD® ATHLOM® microprocessor, DURON® microprocessor OR OPTERON® microprocessor, ARM’s application, embedded or secure processors, IBM® POWERPC®, INTEL’S CORE® processor, ITANIUM® processor, XEON® processor, CELERON® processor or other line of processors, etc. Processor 1004 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1004 may be disposed in communication with one or more input/output (I/O) devices via an I/O interface 1006. I/O interface 1006 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 1002.n /b/g/n/x, Bluetooth, cellular (for example, code-division multiple access (CDMA), high-speed packet access (HSPA+), global system for mobile communications (GSM), long-term evolution (LTE), WiMAX, or the like), etc.

Using I/O interface 1006, computer system 1002 may communicate with one or more I/O devices. For example, an input device 1008 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 1010 may be a printer, fax machine, video display (for example, cathode ray tube (CRT), liquid crystal display (LCD), light-emitting diode (LED), plasma, or the like), audio speaker, etc. In some embodiments, a transceiver 1012 may be disposed in connection with processor 1004. Transceiver 1012 may facilitate various types of wireless transmission or reception. For example, transceiver 1012 may include an antenna operatively connected to a transceiver chip (for example, TEXAS® INSTRUMENTS WILINK WL1286® transceiver, BROADCOM® BCM4550IUB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 1004 may be disposed in communication with a communication network 1014 via a network interface 1016. Network interface 1016 may communicate with communication network 1014. Network interface 1016 may employ connection protocols including, without limitation, direct connect, Ethernet (for example, twisted pair 10/100/1000 Base T), transmission control protocol/internet protocol (TCP/IP), token ring, IEEE 802.11a/b/g/n/x, etc. Communication network 1014 may include, without limitation, a direct interconnection, local area network (LAN), wide area network (WAN), wireless network (for example, using Wireless Application Protocol), the Internet, etc. Using network interface 1016 and communication network 1014, computer system 1002 may communicate with devices 1018, 1020, and 1022. These devices may include, without limitation, personal computer(s), server(s), fax machines, printers, scanners, various mobile devices such as cellular telephones, smartphones (for example, APPLE® IPHONE® smartphone, BLACKBERRY® smartphone, ANDROID® based phones, etc.), tablet computers, eBook readers (AMAZON® KINDLE® reader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 1002 may itself embody one or more of these devices.

In some embodiments, processor 1004 may be disposed in communication with one or more memory devices (for example, RAM 1126, ROM 1128, etc.) via a storage interface 1024. Storage interface 1024 may connect to memory 1030 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 1030 may store a collection of program or database components, including, without limitation, an operating system 1032, user interface 1034, web browser 1036, mail server 1038, mail client 1040, user/application data 1042 (for example, any data variables or data records discussed in this disclosure), etc. Operating system 1032 may facilitate resource management and operation of computer system 1002. Examples of operating systems 1032 include, without limitation, APPLE® MACINTOSH® OS X platform, UNIX platform, Unix-like system distributions (for example, Berkeley Software Distribution (BSD), FreeBSD, NetBSD, OpenBSD, etc.), LINUX distributions (for example, RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 1034 may facilitate display, execution, interaction, manipulation, or operation of program components through textual or graphical facilities. For example, user interfaces may provide computer interaction interface elements on a display system operatively connected to computer system 1002, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (for example, AERO® platform, METRO® platform, etc.), UNIX X-WINDOWS, web interface libraries (for example, ACTIVEX® platform, JAVA® programming language, JAVASCRIPT® programming language, AJAX® programming language, HTML, ADOBE® FLASH® platform, etc.), or the like.

In some embodiments, computer system 1002 may implement a web browser 1036 stored program component. Web browser 1036 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APIs), etc. In some embodiments, computer system 1002 may implement a mail server 1038 stored program component. Mail server 1038 may be an Internet mail server such as MICROSOFT® EXCHANGE® mail server, or the like. Mail server 1038 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. Mail server 1038 may utilize communication protocols such as internet message access protocol (IMAP), messaging application programming interface (MAPI), Microsoft Exchange, post office protocol (POP), simple mail transfer protocol (SMTP), or the like. In some embodiments, computer system 1002 may implement a mail client 1040 stored program component. Mail client 1040 may be a mail viewing application, such as APPLE MAIL® mail-client, MICROSOFT ENTOURAGE® mail client, MICROSOFT OUTLOOK® mail client, MOZILLA THUNDERBIRD® mail client, etc.

In some embodiments, computer system 1002 may store user/application data 1042, such as the data, variables, records, etc. as described in this disclosure. Such databases may be implemented as fault-tolerant, relational, scalable secure databases such as ORACLE® database OR SYBASE® database. Alternatively, such databases may be implemented using standardized data structures, such as an array, hash, linked list, struct, structured text file (for example, XML), table, or as object-oriented databases (for example, using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

The disclosure offers various advantages over traditional systems. The disclosure provides capability to monitor and identify events based on their frequency of occurrence and enables timely detection of recurring patterns or anomalies. By continuously logging events into a memory buffer and incrementing occurrence counts for recurring events, the disclosure can efficiently prioritize significant events, enhancing overall situational awareness and threat detection capabilities. This proactive approach to event categorization ensures that critical events are promptly addressed, minimizing a risk of oversight or delayed responses. Moreover, the disclosure offers an ability to recognize the events based on their similarity to known patterns or templates, enhancing its adaptability and scalability. The disclosure categorizes and learns from similar occurrences by comparing new events with established patterns, even in dynamic and evolving environments. This adaptive learning mechanism allows to continuously refine its categorization algorithms over time, improving accuracy and reducing false positives. Additionally, the disclosure’s contextual awareness enables it to interpret complex and multi-layered events within their broader context, facilitating nuanced analysis and decision-making across various application domains.

Overall, the disclosure offers a comprehensive and efficient approach to event analysis and classification, empowering organizations to effectively manage and respond to diverse scenarios and challenges in real-time. By leveraging advanced technologies such as Artificial Intelligence (AI) and contextual awareness, the disclosure enhances operational efficiency, situational awareness, and decision-making capabilities across a wide range of applications, from security surveillance to healthcare monitoring and beyond.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. An Artificial Intelligence (AI) based method for adaptive categorization of events, the method comprising:
creating, in real-time, a first set of image vectors and a set of attribute vectors from a multimedia event captured via a camera;
comparing, via a trained AI model, the first set of image vectors with a second set of image vectors associated with a plurality of stored multimedia events;
determining, via the trained AI model, a first frequency of prior occurrence of the multimedia event based on the comparing;
comparing the first frequency of prior occurrence with a frequency threshold; and
assigning, via the trained AI model, an event category from a plurality of event categories to the multimedia event, based on comparison of the first frequency with the frequency threshold.

2. The AI based method of claim 1, wherein the plurality of event categories comprises a high priority event category and a low priority event category.

3. The AI based method of claim 2, wherein assigning the event category to the multimedia event comprises:
determining that the first frequency of prior occurrence is greater than the frequency threshold; and
assigning the high priority event category to the multimedia event in response to determining that the first frequency of prior occurrence is greater than the frequency threshold.

4. The AI based method of claim 3, further comprising:
permanently retaining the multimedia event in response to assigning of the high priority event category; and
performing, by the trained AI model, an incremental learning based on the multimedia event.

5. The AI based method of claim 2, wherein assigning the event category to the multimedia event comprises:
determining that the first frequency of prior occurrence is less than or equal to the frequency threshold; and
assigning the low priority event category to the multimedia event in response to determining that the first frequency of prior occurrence is less than or equal to the frequency threshold.

6. The AI based method of claim 5, further comprising:
retaining, in a memory of an edge node, the multimedia event for a predefined time duration; and
performing, at the edge node, a predefined action in response to occurrence of the multimedia event.

7. The AI based method of claim 2, wherein comparing the first set of image vectors with a second set of image vectors comprises identifying a stored multimedia event from the plurality of stored multimedia events, wherein the stored multimedia event is similar to the multimedia event.

8. The AI based method of claim 7, further comprising:
determining a second frequency of prior occurrence of the stored multimedia event;
comparing the second frequency of prior occurrence with the frequency threshold; and
assigning the high priority event category to the multimedia event in response to determining that the second frequency of prior occurrence is greater than the frequency threshold.

9. The AI based method of claim 2, wherein the set of attribute vectors corresponds to a first context associated with the multimedia event.

10. The AI based method of claim 9, further comprising modifying the assigned event category to the multimedia event, based on the set of attribute vectors.

11. An Artificial Intelligence (AI) based system for adaptive categorization of events, the AI based system comprising:
a processor; and
a memory communicatively coupled to the processor, wherein the memory stores processor-executable instructions, which, on execution, causes the processor to:
create, in real-time, a first set of image vectors and a set of attribute vectors from a multimedia event captured via a camera;
compare, via a trained AI model, the first set of image vectors with a second set of image vectors associated with a plurality of stored multimedia events;
determine, via the trained AI model, a first frequency of prior occurrence of the multimedia event based on the comparing;
compare the first frequency of prior occurrence with a frequency threshold; and
assign, via the trained AI model, an event category from a plurality of event categories to the multimedia event, based on comparison of the first frequency with the frequency threshold.

12. The AI based system of claim 11, wherein the plurality of event categories comprises a high priority event category and a low priority event category.

13. The AI based system of claim 12, wherein the processor-executable instructions further cause the processor to assign the event category to the multimedia event by:
determining that the first frequency of prior occurrence is greater than the frequency threshold; and
assigning the high priority event category to the multimedia event in response to determining that the first frequency of prior occurrence is greater than the frequency threshold.

14. The AI based system of claim 13, wherein the processor-executable instructions further cause the processor to:
permanently retain the multimedia event in response to assigning of the high priority event category; and
perform, by the trained AI model, an incremental learning based on the multimedia event.

15. The AI based system of claim 12, wherein the processor-executable instructions further cause the processor to assign the event category to the multimedia event by:
determining that the first frequency of prior occurrence is less than or equal to the frequency threshold; and
assigning the low priority event category to the multimedia event in response to determining that the first frequency of prior occurrence is less than or equal to the frequency threshold.

16. The AI based system of claim 15, wherein the processor-executable instructions further cause the processor to:
retain, in a memory of an edge node, the multimedia event for a predefined time duration; and
perform, at the edge node, a predefined action in response to occurrence of the multimedia event.

17. The AI based system of claim 12, wherein the processor-executable instructions further cause the processor to compare the first set of image vectors with a second set of image vectors by identifying a stored multimedia event from the plurality of stored multimedia events, wherein the stored multimedia event is similar to the multimedia event.

18. The AI based system of claim 17, wherein the processor-executable instructions further cause the processor to:
determine a second frequency of prior occurrence of the stored multimedia event;
compare the second frequency of prior occurrence with the frequency threshold; and
assign the high priority event category to the multimedia event in response to determining that the second frequency of prior occurrence is greater than the frequency threshold.

19. The AI based system of claim 12, wherein the set of attribute vectors corresponds to a first context associated with the multimedia event.

20. The AI based system of claim 19, wherein the processor-executable instructions further cause the processor to modify the assigned event category to the multimedia event, based on the set of attribute vectors.

21. A non-transitory computer-readable medium storing computer-executable instructions for adaptive categorization of events using Artificial Intelligence (AI), when executed by a processor, cause the processor to perform operations comprises:
creating, in real-time, a first set of image vectors and a set of attribute vectors from a multimedia event captured via a camera;
comparing, via a trained AI model, the first set of image vectors with a second set of image vectors associated with a plurality of stored multimedia events;
determining, via the trained AI model, a first frequency of prior occurrence of the multimedia event based on the comparing;
comparing the first frequency of prior occurrence with a frequency threshold; and
assigning, via the trained AI model, an event category from a plurality of event categories to the multimedia event, based on comparison of the first frequency with the frequency threshold.
